(19) United States
(12) Patent Application Publication
(10) Pub. No.: US 2007/0266150 A1
(43) Pub. Date: Nov. 15, 2007

(54) SYSTEMS AND METHODS FOR SELF-CHECKING AND IDENTIFYING ERRORS IN RICH-MEDIA ADVERTISEMENTS

(75) Inventors: Hyo Lee, Pasadena, CA (US); Peter H.I. Kim, Pasadena, CA (US)

Correspondence Address: BAKER & MCKENZIE LLP;PATENT DEPARTMENT, 2001 ROSS AVENUE, SUITE 2300, DALLAS, TX, 75201, US

(73) Assignee: INTERPOLS NETWORK INCORPORATED, Pasadena, CA (US)

(21) Appl. No.: 11/747,084

(22) Filed: May 10, 2007

Related U.S. Application Data
(60) Provisional application No. 60/746,959, filed on May 10, 2006.

(51) Int. Cl. G06F 11/00; G06F 15/173

(52) U.S. Cl. 709/224; 714/25

(57) ABSTRACT

A system for identifying errors in an advertisement unit, is disclosed. The system includes a web browser, a web server, and an advertisement server. The web browser is configured to generate a request for a webpage. The web server is communicatively connected to the web browser and is configured to receive the request for a webpage from the web browser and send the requested webpage to the browser in response to the request. The webpage includes an ad unit request script that is configured to direct the web browser to generate a request for an advertisement unit.

The advertisement server is communicatively connected to the web browser and the web server. The advertisement server is configured to receive the advertisement unit request and send the advertisement unit to the web browser in response to the advertisement unit request. Each advertisement unit includes an error checking call script configured to direct the web browser to generate a request for an error checking script from the advertisement server. Each error checking script is configured to recognize errors in the advertisement unit rendered on the web browser and generate a report summarizing those errors.

### APPLICATIONS FOR CLAIM OF PRIORITY

This application claims the benefit of U.S. Provisional Application No. 60/746,959 filed May 10, 2006. The entirety of the disclosure of the above-identified application is incorporated herein by reference.

### BACKGROUND

1. Field of the Invention

The embodiments disclosed in this application generally relate to Internet advertising and more specifically to techniques for discerning errors on the Internet advertising units rendered on web browsers.

2. Background of the Invention

Internet advertising initially emerged as graphical banners with static images that redirected users to a new webpage when clicked. As Internet technology matured, the techniques used to create Internet advertising content has matured along with it. Simple animation was introduced when animated Graphic Interchange Format files (GIFs) were popularized. Client-side JAVASCRIPT™ was used to add some interactivity in ads when more web browsers started supporting the format.

Later, Macromedia FLASH™, a plug-in that gives web browsers the ability to show vector graphics, was introduced into the fold. This allowed programmers to introduce fluid animation to web sites. Moreover, additional functionality and user interactivity has been added to each successive version of FLASH™. Now, FLASH™ has become one of the most widely accepted 3^{rd} party plug-ins and is included with many new web browsers. As more web sites started using FLASH™, they also started accepting rich-media ads created in FLASH™ as well. This began the era of true rich-media advertising on the Internet where ads were created to be animated, make sounds, and to be interactive with users. But these rich-media banners were purely dependent on FLASH™ plug-ins for its functions. Users without FLASH™ plug-ins get a static image.

Some Internet advertisers decided early on that their technology could not be tied to any proprietary 3^{rd} party technologies (i.e., FLASH™). Therefore, their ad units are based on universally accepted web standards like Cascading Style Sheets (CSS) and Dynamic HyperText Mark-up Language (DHTML) to present interactive ads to users. Because the CSS and DHTML formats are the base descriptive language for all web content, ad units created in CSS/DHTML can incorporate any current and future technologies—including, but not limited to FLASH™, JAVA™, other ACTIVEX™ Plug-ins, XML, etc.

But this flexibility comes at a price. Many modern web sites use CSS to define the look-and-feel of the webpage elements that are delivered to and rendered on a web browser. This type of “global definition” of how things should look on a rendered webpage can also interfere with the DHTML banner ads that are rendered with the webpage. It can result in ad units being placed in the wrong location, it can put random borders around elements, it can resize text display, it can misalign any elements, etc. In short, when any of the attributes are incorrectly defined, it can spill into the definition of DHTML rich-media ad unit and wreak havoc with its formatting. It's not just the definition of CSS. Web publishers can make mistakes with their webpages when implementing the code necessary for the DHTML rich-media ad units. They can render the ad unit in an incorrectly sized window (if the ad unit is a popup), put the ad unit in a wrong location where it can't be seen, etc. The rich-media ads themselves can contain errors. They might redirect users to the wrong affiliate sites, the might not have the right tracking abilities, etc.

Any of these types of errors can hamper a user's experience while on a website and turn users off to the product message that the ad is trying to sell. As such, these errors may lower the overall performance (response rate, click rate, etc.) of the rich-media ad unit.

Currently, there is no way to check the ad units for formatting errors once they have been rendered on a web browser. These ad units are susceptible to formatting errors, when rendered on a web browser, due to interference by their hosting web sites—sometimes even if they are protected by an iframe.

### SUMMARY

Methods and systems for self-checking and identifying errors in an advertisement unit are disclosed.

In one aspect, a system for identifying errors in an advertisement unit, is disclosed. The system includes a web browser, a web server, and an advertisement server. The web browser is configured to generate a request for a webpage. The web server is communicatively connected to the web browser and is configured to receive the request for a webpage from the web browser and send the requested webpage to the browser in response to the request. The webpage includes an ad unit request script that is configured to direct the web browser to generate a request for an advertisement unit.

The advertisement server is communicatively connected to the web browser and the web server. The advertisement server is configured to receive the advertisement unit request and send the advertisement unit to the web browser in response to the advertisement unit request. Each advertisement unit includes an error checking call script configured to direct the web browser to generate a request for an error checking script from the advertisement server. Each error checking script is configured to recognize errors in the advertisement unit rendered on the web browser and generate a report summarizing those errors.

In another aspect, a method for identifying errors in an advertisement unit, is disclosed. The advertisement unit is rendered on a web browser. An error checking script is requested. The error checking script is received. The error checking script is executed on the web browser. During the execution of the error checking script, the rendered advertisement unit is compared against the predicted rendered advertisement unit parameters to identify errors in the rendered advertisement. A summary report is generated to detail the errors identified.

In a different aspect, another method for identifying errors in an advertisement unit, is disclosed. The advertisement unit is rendered on a web browser. An error checking script is requested. The error checking script is received. The error checking script is executed on the web browser. The rendered advertisement unit is searched for errors. The rendered advertisement unit is searched for errors. A summary report is generated that details the errors identified during the search.

These and other features, aspects, and embodiments of the invention are described below in the section entitled “Detailed Description.”

### BRIEF DESCRIPTION OF THE DRAWINGS

For a more complete understanding of the principles disclosure herein, and the advantages thereof, reference is now made to the following descriptions taken in conjunction with the accompanying drawings, in which:

FIG. 1 is a diagram illustrating an example process for identifying formatting errors in an Internet advertisement, in accordance with one embodiment.

FIG. 2 is an illustration of an advertisement unit with misaligned elements, in accordance with one embodiment.

FIG. 3 is an illustration of an advertisement unit with a deformed ad unit button, in accordance with one embodiment.

FIG. 4 is an illustration of an advertisement unit that is too large, in accordance with one embodiment.

FIG. 5 is an illustration of an advertisement unit that is too tall, in accordance with one embodiment.

FIG. 6 is an illustration of an advertisement unit that contains irregular borders and padding spaces, in accordance with one embodiment.

FIG. 7 is an illustration of an advertisement unit that has an element that has been forced to align to one side, in accordance with one embodiment.

### DETAILED DESCRIPTION

An invention is described for methods and systems for self-checking and identifying errors in an advertisement unit rendered on a web browser. It will be obvious, however, that the present invention may be practiced without some or all of these specific details. In other instances, well known process operations have not been described in detail in order not to unnecessarily obscure the present invention.

As used herein, the Internet or World Wide Web (WWW) uses a hypermedia (i.e., comprising of graphics, audio, video, plain text, hyperlinks, etc.) based system for enabling the browsing of Internet sites. As its name implies, the WWW (i.e., Internet) is made of many websites linked together allowing users to travel from one website to another simply by clicking on hyperlinks. To access the web, a user (i.e., client) typically runs a web browser program (e.g., FIREFOX™, NETSCAPE™, INTERNET EXPLORER™, SAFARI™, OPERA™, CAMINO™, etc.) that assists the user in navigating from among the various websites on the WWW and renders the web pages associated with those websites for viewing by the user.

Cascading Style Sheets (CSS) is a stylesheet language used to describe the presentation of a document written in a markup language. Its most common application is to style web pages written in HyperText Markup Language (HTML), DHTML, Extensible HyperText Markup Language (XHTML), but the language can be applied to any kind of Extensible Markup Language (XML) based document, including Scalable Vector Graphics (SVG) and XML User Interface Language (XUL). DHTML denotes a collection of technologies used together to create interactive and animated web sites by using a combination of a static markup language (i.e., HTML), a client-side scripting language (such as JAVASCRIPT™), a presentation definition language (i.e., CSS), and a Document Object Model. DHTML based webpages use client-side scripting to change the variables of the presentation definition language (i.e., HTML) to affect the look and function of otherwise “static” HTML page content, after the page has been fully loaded and during the rendering process. An iframe denotes an HTML element that is rendered within another HTML element. Iframes behave much like an inline image in that they allow users to can scroll them in and out of view

Internet advertisements can take any form as along as it can be rendered onto a web browser or equivalent application. Examples include: static graphical banners, interactive polls, interactive games, multimedia clips, etc. Rich-media denotes interactive multimedia web content that includes audio, graphics, image, video and animation in addition to traditional media (text and graphics).

In view of the foregoing, it should therefore be fully appreciated that a variety of Internet advertising content (e.g., animated ads, interactive polls, multi-media ads, etc.) can benefit from the systems and methods described herein.

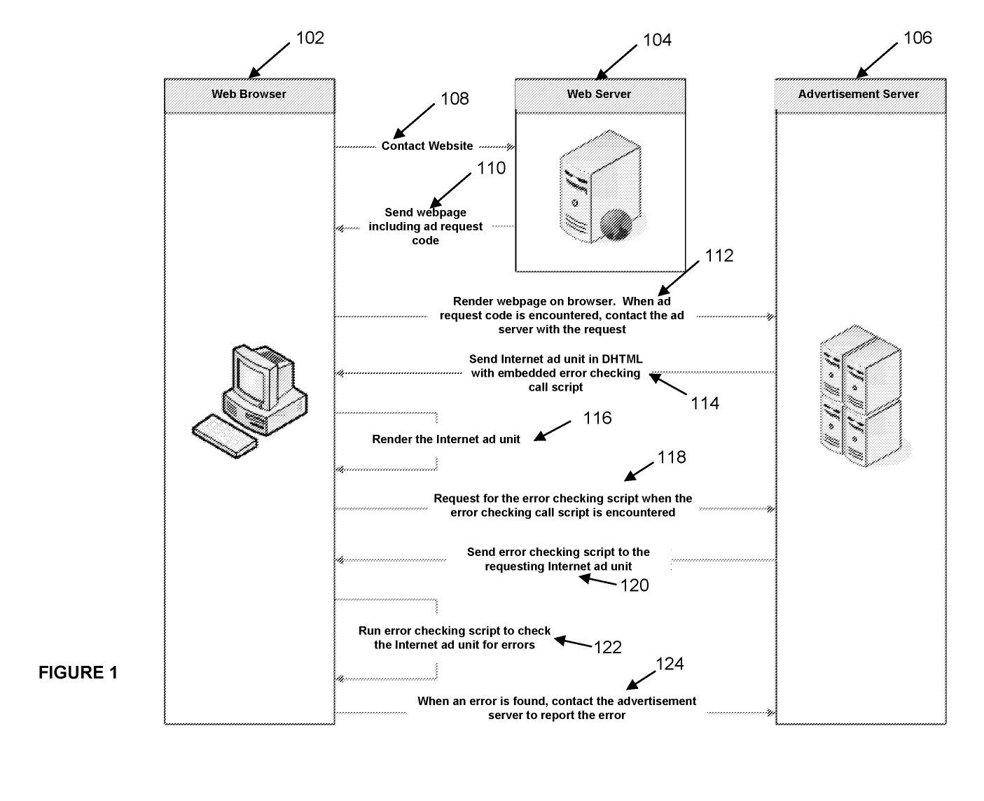

FIG. 1, is a diagram illustrating an example process for identifying formatting errors in an Internet advertisement, in accordance with one embodiment. First, in step 108, the web browser 102 can contact the web server 104 (e.g., Internet content server, affiliate website server, etc.) to deliver a webpage associated with a website that is stored on the server 104. In one embodiment, the webpage is in HTML format. In another embodiment, the webpage is in XHTML format. It should be understood, however, that the webpage can essentially be created in any hypertext language format as long as a web browser 102 can be configured to properly render the webpage.

In step 110, the web server 104 returns a webpage to the web browser 102 along with an ad request script (i.e., ad request code) that is configured to direct the web browser 102 to request an advertisement unit to be sent from the advertisement server 106. Typically, the webpage is requested and served from the web server 104 using Hypertext Transfer Protocol (HTTP) or equivalent communications transmission protocol. In one embodiment, the ad request script is directly embedded within the webpage that is returned to the web browser 102. In another embodiment, the web server 104 delivers an ad server code (served in conjunction with the webpage) that calls for the ad request script to be sent to the web browser 102. The ad request code can be written using a number of different programming languages, the most common of which are JAVASCRIPT™, VBSCRIPT™, and ACTIONSCRIPT™.

In step 112, the webpage is rendered by the web browser 102 and when the ad request script is encountered, the web browser 102 can contact the advertisement server 106 with a request for an advertisement unit. In one embodiment, once the request is received the advertisement server 106 is configured to examine an existing profile of a user associated with the web browser 102 before choosing an appropriate advertisement unit to return back to the web browser 102. Typically, the existing profile contains historical information regarding previous communication sessions between the advertisement server 106 and the user. If a profile does not already exist for the user, the advertisement server 106 is further configured to create a new profile for the user and log the identity of the advertisement unit that is eventually selected and delivered to the user.

In one embodiment, the client profiles are stored in a storage area (e.g., partitioned memory space, extra hard drive, etc.) within the advertisement server 106. In another embodiment, the profiles are stored on an external storage medium (e.g., hard drive, CD-ROM, etc.) that is communicatively linked to the advertisement server 106. Examples of historical information that may impact the advertisement units chosen include: information about advertisement units that have already been sent to the user, information regarding user response to those previous advertisements, and user demographics information.

In another embodiment, once the request is received, the advertisement server 106 is configured to choose an advertisement unit to send based on the content of the webpage that was sent from the web server 104 to the web browser 102. In still another embodiment, the advertisement server 106 is configured to choose an advertisement unit based on historical information and whether the content rating (e.g., G ‘general audience’, PG ‘parental guidance suggested’, PG-13 ‘parental guidance suggested for those under 13 years of age’, and R ‘restricted for those under 17 years of age’, etc.) of the advertisement unit exceeds the content rating level of the web page.

Moving on to step 114, the advertisement server 106 can send the advertisement unit, chosen during step 112, to the web browser 102. In one embodiment, the advertisement unit is created in DHTML format. In another embodiment, the advertisement unit is created in a combination DHTML/CSS format. It should be understood that the advertisement unit can be created in any hypertext markup language format as long as a plug-in is not required in order for the unit to be rendered in a web browser 102.

Embedded within the advertisement unit is an error checking call script that is configured to direct the web browser 102 to request the advertisement server to send an error checking script. In one embodiment, the error checking call script is written in JAVASCRIPT™. In another embodiment, the error checking call script is written in VBSCRIPT™. In still another embodiment, the error checking call script is written in ACTIONSCRIPT™.

In step 116, the advertisement unit is received by the web browser 102 and can be rendered by the same. Typically, this involves the web browser 102 parsing the underlying HTML of the advertisement unit and rendering the unit in accordance with the specifications and instructions set therein.

Continuing on to step 118, when the error checking call script is encountered during the rendering of the advertisement unit, a request can be generated to call for an error checking script to be sent from the advertisement server 106 to the unit. In one embodiment, the error checking script is uniquely associated with the rendered ad unit. That is, the error checking script requested can only be applied to check a rendered advertisement unit with a specific ad unit identification (ID) code. In another embodiment, the error checking script in non-specific to any advertisement unit. That is, the error checking script can be “universally” applied to check any rendered advertisement unit.

In step 120, the advertisement server 106 sends the error checking script to the requesting advertisement unit. Typically, the error checking script is requested and served from the advertisement server 106 using HTTP or equivalent communications transmission protocol.

Proceeding on to step 122, the error checking script is executed to check the advertisement unit for errors. This is done by comparing the physical parameters of the rendered advertisement unit against predicted advertisement unit parameters. Examples of advertisement unit parameters include, but are not limited to: the physical dimensions (i.e., height and width) of the advertisement unit, the position of the advertisement unit relative to other features rendered in the web browser 102, the look and feel of various components (e.g., borders, padding spaces, etc.) of the advertisement unit, etc. It should be appreciated that essentially any aspect of the advertisement unit can be checked by the error checking script as long as that aspect can be translated into a measurable parameter that can be recognized by the error checking script. An error is logged whenever the rendered an ad unit parameter value fails to match its associated predicted ad unit parameter value.

As alluded to above, there are various things the error checking script can check for during the matching operation. In one embodiment, the error checking script can look for items with conflicts that resides on the webpage and adjusts accordingly. This usually happens when there are multiple expanding ad units on a single webpage. In another embodiment, the error checking script can look for all items on the webpage to see if there are things covering the ad unit. This is a real problem on some sites where their malformed CSS layers will cover the advertisement buttons so it can't be clicked on and such.

In still another embodiment, the error checking script catalogs every single visible element and checks their size to make sure they are within specifications. It does this by comparing how big the element is to how much of the element is visible. If the visible area of the element is smaller than the actual size of the element (and it's not by design), the script concludes that something is getting cut-off during rendering or that something else is wrong.

When the error checking script reports back the errors, it reports back with as much information about the user's configuration as it can. Including user's screen width and height, browser type, browser version, OS version, actual URL of the website that was serving the ad that the user was on, etc.

The advertisement server 106 typically does not get alerted for every single error identified by the script (users are bound to have their fonts too big, or have some international language font that's pushing things out, etc.) so only when a predetermined threshold is reached, will the error checking script alert the advertisement server 106. After, either the advertisement server 106 or a system administrator can sift through the report to address the identified problems. That predetermined threshold can be set to anything, a percentage of the impressions that generate an error, a specified error count number reached, etc.

In one embodiment, the advertisement server 106 can automatically classify the errors to indicate their level of severity. In another embodiment, the system administrator reviews the errors logged by the advertisement server 106 and manually classifies them based on severity.

In step 124, all the errors identified by the error checking script are compiled into a report. In one embodiment, the report is sent back to the advertisement server 106 and stored for viewing by a system administrator. In another embodiment, the report is sent back to the advertisement server 106 and processed to supply the advertisement server 106 with the information necessary to create a new advertisement unit that corrects for the errors in the rendered unit.

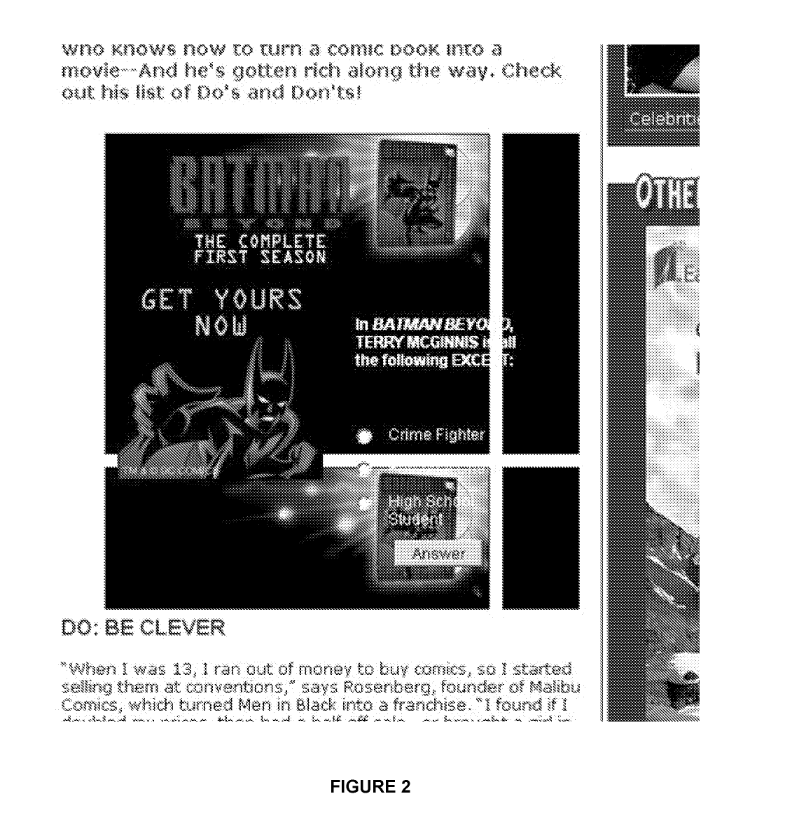

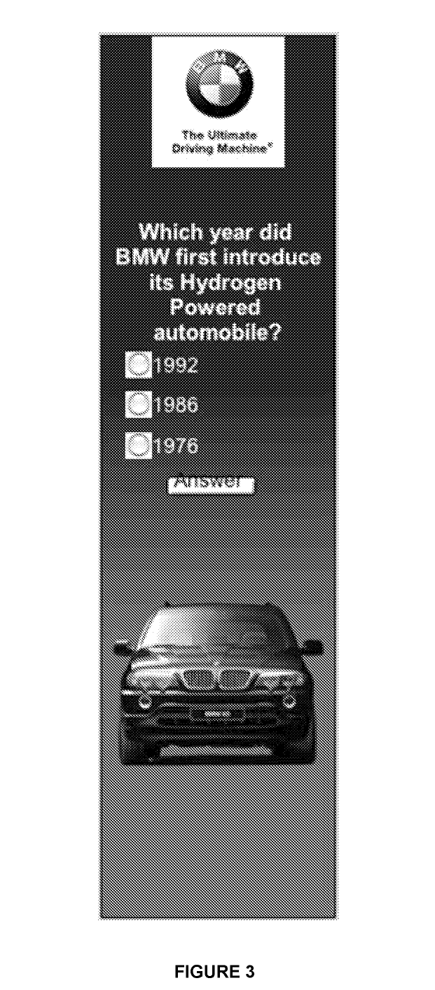

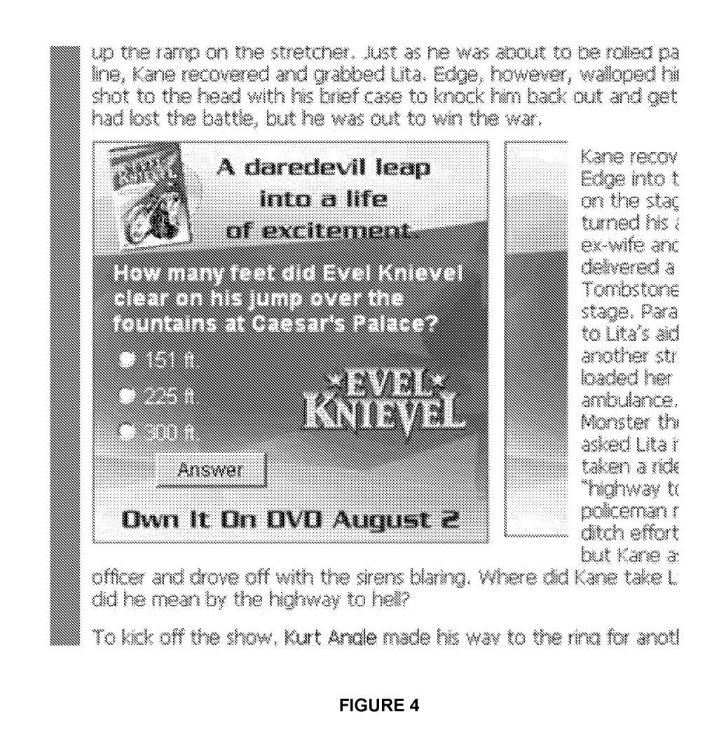

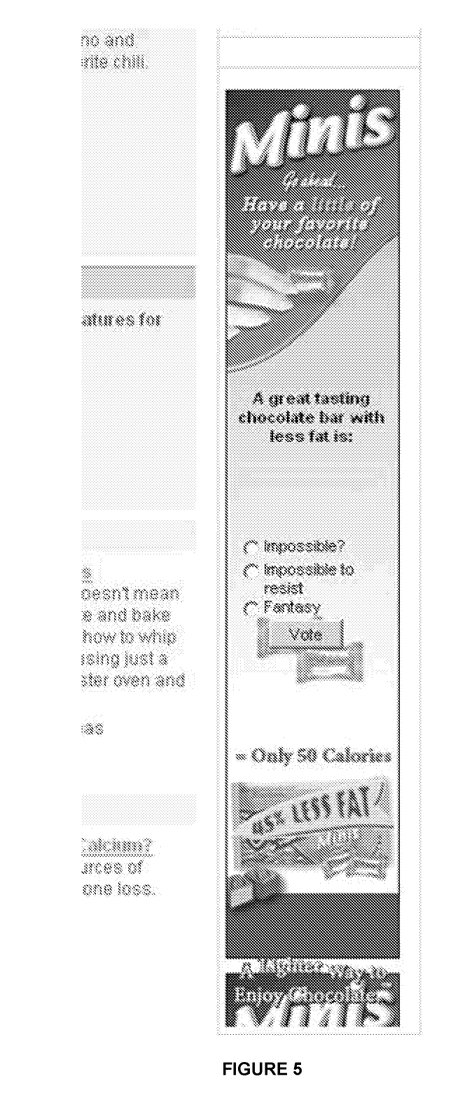

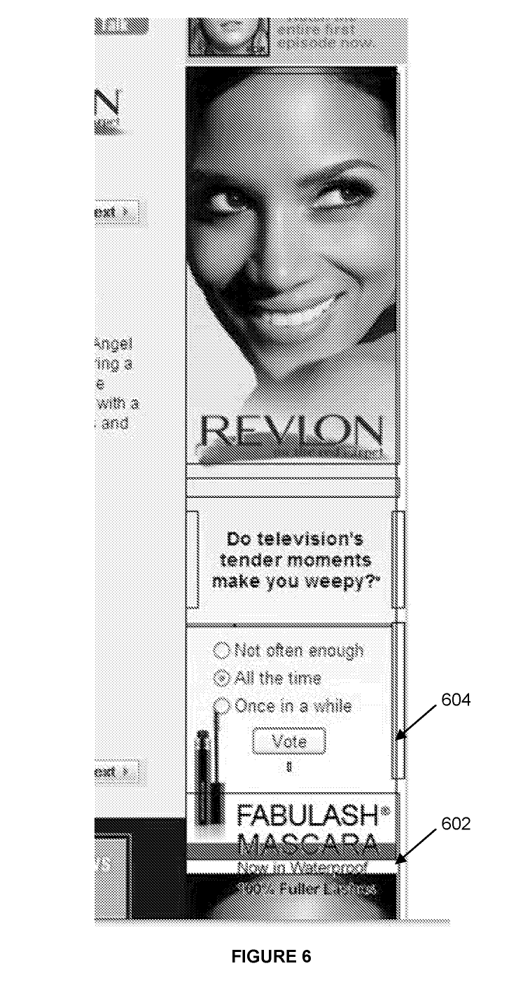

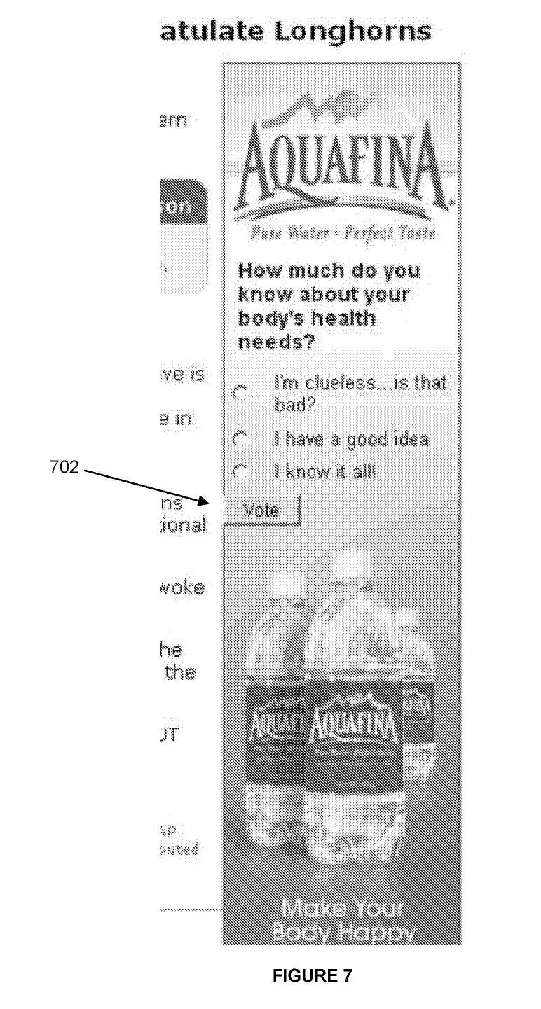

Examples of the types of errors that can be identified by the error checking script include: misaligned ad unit elements 202 (FIG. 2), deformed ad unit buttons 302 (FIG. 3), ad units that are too large (FIG. 4), ad units that are too tall (FIG. 5), ad units that contain irregular borders 602 and padding spaces 604 (FIG. 6), and ad units with elements 702 that are forced aligned to one side (FIG. 7). It should be understood, however, that the types of errors presented above are provided here by way of example only, in practice the error checking script can be configured to identify essentially any type of error as long as it can be translated into a measurable parameter that can be recognized by the error checking script.

Any of the operations that form part of the embodiments described herein are useful machine operations. The invention also relates to a device or an apparatus for performing these operations. The systems and methods described herein can be specially constructed for the required purposes, such as the carrier network discussed above, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The embodiments described herein can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion.

Certain embodiments can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion.

Although a few embodiments of the present invention have been described in detail herein, it should be understood, by those of ordinary skill, that the present invention may be embodied in many other specific forms without departing from the spirit or scope of the invention. Therefore, the present examples and embodiments are to be considered as illustrative and not restrictive, and the invention is not to be limited to the details provided therein, but may be modified and practiced within the scope of the appended claims.

What is claimed is:

1. A system for identifying errors in an advertisement unit, comprising:
a web browser configured to generate a request for a webpage;
a web server communicatively connected to the web browser, the web server configured to receive the webpage request from the web browser and send the webpage to the web browser in response to the webpage request, wherein the webpage includes an ad unit request script configured to direct the web browser to generate a request for the advertisement unit; and
an advertisement server communicatively connected to the web browser and the web server, the advertisement server configured to receive the advertisement unit request and send the advertisement unit to the web browser in response to the advertisement unit request,
wherein, the advertisement unit includes an error checking call script configured to direct the web browser to generate a request for an error checking script from the advertisement server, and
wherein, the error checking script is configured to recognize errors in the advertisement unit rendered on the web browser and generate a report summarizing those errors.

2. The system for identifying errors in an advertisement unit, as recited in claim 1, wherein the ad unit request script is embedded within the webpage.

3. The system for identifying errors in an advertisement unit, as recited in claim 1, wherein the ad unit request script is sent in conjunction with the webpage in a separate iframe.

4. The system for identifying errors in an advertisement unit, as recited in claim 1, wherein the ad unit request script is called by an ad server code that is served in conjunction with the webpage to the web browser.

5. The system for identifying errors in an advertisement unit, as recited in claim 1, wherein the ad unit request script is composed in JAVASCRIPT™ format.

6. The system for identifying errors in an advertisement unit, as recited in claim 1, wherein the ad unit request script is composed in VBSCRIPT™ format.

7. The system for identifying errors in an advertisement unit, as recited in claim 1, wherein the ad unit request script is composed in ACTIONSCRIPT™ format.

8. The system for identifying errors in an advertisement unit, as recited in claim 1, wherein the error checking call script is composed in JAVASCRIPT™ format.

9. The system for identifying errors in an advertisement unit, as recited in claim 1, wherein the error checking call script is composed in VBSCRIPT™ format.

10. The system for identifying errors in an advertisement unit, as recited in claim 1, wherein the error checking call script is composed in ACTIONSCRIPT™ format.

11. The system for identifying errors in an advertisement unit, as recited in claim 1, wherein the error checking call script is specifically assigned to the advertisement unit.

12. The system for identifying errors in an advertisement unit, as recited in claim 1, wherein the web browser is further configured to send the report to the advertisement server.

13. The system for identifying errors in an advertisement unit, as recited in claim 1, wherein the errors include deformed buttons in the advertisement unit.

14. The system for identifying errors in an advertisement unit, as recited in claim 1, wherein the errors include the advertisement unit being too large.

15. The system for identifying errors in an advertisement unit, as recited in claim 1, wherein the errors include misaligned elements within the advertisement unit.

16. The system for identifying errors in an advertisement unit, as recited in claim 1, wherein the errors include the advertisement unit being too tall.

17. The system for identifying errors in an advertisement unit, as recited in claim 1, wherein the errors include the advertisement unit having irregular borders and padding space.

18. A method for identifying errors in an advertisement unit, comprising:
rendering the advertisement unit on a web browser;
requesting an error checking script;
receiving the error checking script; and
executing the error checking script on the web browser, wherein, the execution of the error checking script includes,
comparing the rendered advertisement unit against predicted rendered advertisement unit parameters,
identifying errors in the rendered advertisement unit based on the comparison, and
generating a summary report detailing the errors identified.

19. The method for identifying errors in an advertisement unit, as recited in claim 18, wherein the error checking script is requested when the web browser encounters an embedded error checking call script while rendering the advertisement unit.

20. The method for identifying errors in an advertisement unit, as recited in claim 18, wherein the error checking script is composed in JAVASCRIPT™ format.

21. The method for identifying errors in an advertisement unit, as recited in claim 18, wherein the error checking script is composed in VBSCRIPT™ format.

22. The method for identifying errors in an advertisement unit, as recited in claim 18, wherein the error checking script is composed in ACTIONSCRIPT™ format.

23. The method for identifying errors in an advertisement unit, as recited in claim 18, wherein the error checking script is specifically assigned to the advertisement unit.

24. The method for identifying errors in an advertisement unit, as recited in claim 18, further including:
sending the report to the advertisement server.

25. The method for identifying errors in an advertisement unit, as recited in claim 18, wherein the predicted rendered advertisement unit parameters include a predicted alignment of the rendered advertisement unit.

26. The method for identifying errors in an advertisement unit, as recited in claim 18, wherein the predicted rendered advertisement unit parameters include a predicted height of the rendered advertisement unit.

27. The method for identifying errors in an advertisement unit, as recited in claim 18, wherein the predicted rendered advertisement unit parameters include predicted border and padding space of the rendered advertisement unit.

28. The method for identifying errors in an advertisement unit, as recited in claim 18, wherein errors are logged during the comparison whenever the rendered advertisement unit differs from the predicted rendered advertisement unit parameters.

29. A method for identifying errors in an advertisement unit, comprising:
rendering the advertisement unit on a web browser;
requesting an error checking script;
receiving the error checking script;
searching for errors in the rendered advertisement unit; and
generating a summary report detailing errors identified during the search.

30. The method for identifying errors in an advertisement unit, as recited in claim 29, wherein the error checking script is requested when the web browser encounters an embedded error checking call script while rendering the advertisement unit.

31. The method for identifying errors in an advertisement unit, as recited in claim 29, wherein the error checking call script is specifically assigned to the advertisement unit.

32. The method for identifying errors in an advertisement unit, as recited in claim 29, further including:
sending the report to the advertisement server.

33. The method for identifying errors in an advertisement unit, as recited in claim 29, wherein the predicted rendered advertisement unit parameters include a predicted alignment of the rendered advertisement unit.

34. The method for identifying errors in an advertisement unit, as recited in claim 29, wherein the predicted rendered advertisement unit parameters include a predicted height of the rendered advertisement unit.

35. The method for identifying errors in an advertisement unit, as recited in claim 29, wherein the predicted rendered advertisement unit parameters include predicted border and padding space of the rendered advertisement unit.

36. The method for identifying errors in an advertisement unit, as recited in claim 29, wherein errors are logged during the comparison whenever the rendered advertisement unit differs from the predicted rendered advertisement unit parameters.
